(19) United States
(12) Patent Application Publication
(10) Pub. No.: US 2022/0222286 A1
(43) Pub. Date: Jul. 14, 2022

(54) KNOWLEDGE INFORMATION CREATION ASSIST APPARATUS

(71) Applicants: KABUSHIKI KAISHA TOSHIBA, Minato-ku (JP); TOSHIBA DIGITAL SOLUTIONS CORPORATION, Kawasaki-shi (JP)

(72) Inventors: Yoshikata TOBITA, Nishitokyo (JP); Masaru SUZUKI, Kawasaki (JP); Hideo MIZUSAWA, Yokohama (JP); Masahisa SHINOZAKI, Tokorozawa (JP); Satoshi SONOH, Chigasaki (JP); Kentaro FURIHATA, Kawasaki (JP); Guowei ZU, Hachioji (JP)

(73) Assignees: KABUSHIKI KAISHA TOSHIBA, Minato-ku (JP); TOSHIBA DIGITAL SOLUTIONS CORPORATION, Kawasaki-shi (JP)

(21) Appl. No.: 17/269,377

(22) PCT Filed: Oct. 30, 2019
(86) PCT No.: PCT/JP2019/042494

§ 371 Date: Feb. 18, 2021

(30) Foreign Application Priority Data
Nov. 6, 2018 (JP) 2018-208753

(51) Int. Cl. G06F 16/35; G06F 3/0482; G06F 16/332

(52) U.S. Cl. CPC G06F 16/355; G06F 16/3329; G06F 3/0482

(57) ABSTRACT

A knowledge information creation assist apparatus assists creation of knowledge information relating to a question, for example FAQs can be created from past user accumulated support histories. The apparatus includes: an input controller configured to control upload of plural user support histories including questions; a screen controller configured to perform first display control for displaying, on a display apparatus, a question group creation screen including group information of each of question groups created from the user support histories classified according to a predetermined classification model and second display control for displaying a knowledge information creation screen for producing knowledge information in response to input performed by a creator to one of the question groups selected on the question group creation screen; and an output controller configured to produce output data of the knowledge information created for each question group on the knowledge information creation screen.

### TECHNICAL FIELD

Embodiments of the present invention relate to a technique for assisting creation of knowledge information such as FAQs.

### BACKGROUND ART

Techniques for assisting interactions by means of FAQs have conventionally been used. FAQs or frequently asked questions are combinations of questions and answers created, for example, from user support histories. FAQs are used by operators serving users in contact centers or are put on websites as a guidance tool for users to find answers of questions or solutions of problems.

### PRIOR ART DOCUMENTS

### Patent Documents

[Patent Document 1] Japanese Patent No. 4081065

[Patent Document 2] Japanese Patent No. 6200602

### DISCLOSURE OF THE INVENTION

### Problems to be Solved by the Invention

It is an object of the present invention to provide a knowledge information creation assist apparatus capable of easily creating knowledge information such as FAQs from user support histories accumulated in the past without cumbersome operation.

### Means for Solving the Problems

According to an embodiment, a knowledge information creation assist apparatus provides a function of assisting creation of knowledge information relating to a question. The apparatus includes an input control section configured to control upload of a plurality of user support histories including questions; a screen control section configured to perform first display control for displaying, on a display apparatus, a question group creation screen including group information of each of question groups created from the user support histories classified according to a predetermined classification model and second display control for displaying, on the display apparatus, a knowledge information creation screen for producing knowledge information based on input performed by a creator to one of the question groups selected on the question group creation screen; and an output control section configured to produce output data of the knowledge information created for each of the question groups on the knowledge information creation screen.

### BRIEF DESCRIPTION OF THE DRAWINGS

FIG. 1 A diagram showing the configuration of a network including a computer system to which a knowledge information creation assist apparatus according to Embodiment 1 of the present invention is applied.

FIG. 2 A diagram showing functional blocks and an example of accumulated user support logs in the knowledge information creation assist apparatus according to Embodiment 1.

FIG. 3 A diagram for explaining an assist function provided by the knowledge information creation assist apparatus according to Embodiment 1.

FIG. 4 A flow chart showing a knowledge information creation procedure in which the knowledge information creation assist apparatus according to Embodiment 1 is applied.

FIG. 5 A flow chart showing the knowledge information creation procedure subsequent to that shown in FIG. 4.

FIG. 6 A diagram showing an example of a question group creation screen according to Embodiment 1.

FIG. 7 A diagram showing an example of the display result from narrowing condition processing on the question group creation screen according to Embodiment 1.

FIG. 8 A diagram showing a manner of display of read existing FAQs on the question group creation screen according to Embodiment 1.

FIG. 9 A diagram showing an example of display control for a link (association) between a group display panel and an existing FAQ on the question group creation screen according to Embodiment 1.

FIG. 10 A diagram showing an example of display control for group display panels on the question group creation screen according to Embodiment 1.

FIG. 11 A diagram showing an example of an FAQ creation screen including an edit screen block and a reference information block according to Embodiment 1 and showing an example of display of “associated user support log” in the reference information block.

FIG. 12 A diagram showing an example of the FAQ creation screen including the edit screen block and the reference information block according to Embodiment 1 and showing an example of display of “similar existing FAQ” in the reference information block.

FIG. 13 A diagram showing an example of the FAQ creation screen including the edit screen block and the reference information block according to Embodiment 1 and showing an example of display of “automatic extraction result” in the reference information block.

FIG. 14 A diagram showing an example in which a grouping model used in the knowledge information creation assist function according to Embodiment 1 is applied to an FAQ search function in a contact center.

### MODE FOR CARRYING OUT THE INVENTION

An embodiment of the present invention will be described with reference to the accompanying drawings.

### Embodiment 1

FIGS. 1 to 14 are diagrams showing a knowledge information creation assist system according to Embodiment 1. FIG. 1 is a diagram showing the configuration of a computer system to which a knowledge information creation assist apparatus 100 according to Embodiment 1 (hereinafter referred to as an assist apparatus) is applied.

An example of knowledge information is FAQs (Frequently Asked Questions), and the FAQs are formed of combinations of questions and answers (the combinations of questions and answers do not necessarily have one-to-one correspondence but may have one-to-n or n-to-one correspondence). As described above, the FAQs can be used by operators serving users in contact centers to achieve efficient responses to users, thereby streamlining the operation in contact centers. The FAQs can also be put on websites to help users solve their questions or problems with reference to the FAQs, which can enhance convenience for users and can reduce the number of inquiries (the number of incoming calls) in contact centers.

In general, the FAQs are often created by managers based on a large amount of user support logs in the past (user support histories), and involves a significant burden and cost in creating and maintaining (updating) the FAQs. Since all the large amount of user support logs cannot be reviewed, the quality of the FAQs may depend on the managers.

To reduce the burden of creation and maintenance of the FAQs, techniques have been proposed for automatically classifying user support logs and automatically creating optimal FAQs (For example, see Patent Documents 1, 2). However, the automatically created FAQs cannot necessarily be put to practical use as they are. In reality, those FAQs are corrected by managers, or in some cases, FAQs are created manually.

To address this, the assist apparatus 100 according to Embodiment 1 provides an environment in which FAQs can be created manually from a large amount of user support logs without cumbersome operation. Specifically, the assist apparatus 100 provides the following principal functions of assisting creation of knowledge information through a user interface function:

(1) a function of acquiring (uploading) user support logs;

(2) a function of grouping and displaying the user support logs;

(3) a function of reading and displaying existing FAQs;

(4) a function of creating an FAQ based on the grouped user support logs; and

(5) a function of outputting the created FAQ.

First, description is made of an example of accumulation of user support logs and use of FAQs in conjunction with the example shown in FIG. 1.

In a contact center system, an operator interacts with a user via telephone (call), chat, or e-mail to answer a question (inquiry) from the user. A user support log in which the interaction is recorded is managed and accumulated in a customer support management apparatus 330 and can be used to provide a function of assisting the operator in user support by presenting FAQs through an FAQ search function.

The customer support management apparatus 330 can accumulate the user support log, for example, in an operator input scheme in which a predetermined input screen is displayed on an operator terminal 300 to allow input of the user support log by the operator (mainly the content of the question and the answer).

The content of voice interaction with the user via a user terminal 500 can be converted into text through voice recognition and the text can be compared with FAQs to search for and display any FAQ appropriate for the content of the interaction on a display apparatus of the operator terminal 300. The same applies to chat, in which case the content of interaction through time-series text messages can be used to search for and display any FAQ appropriate for that content. In this case, the customer support management apparatus 330 can automatically manage and accumulate a series of interactions in text form as a user support log (automatic input scheme).

In addition to the automatic search scheme involving automatic matching with the content of interaction, the FAQ search function includes, for example, a manual search scheme in which the operator inputs a keyword and performs manual search on an FAQ search screen and then any suitable FAQ is displayed as the result of the search. In the manual search scheme, the operator can also search a list of FAQs and display any suitable FAQ. The FAQ search function can allow both of the automatic search scheme and the manual search scheme.

In the automatic search scheme described above, the matching between the content of interaction and the FAQs can be performed by means of a query model and a search model using a classification learner. The classification learner employs various techniques, and for example, can quantify (weight) each word in a document based on the number of appearances or the similarity between words to utilize a known technique such as a Naïve Bayes classifier which is one of classification techniques in machine learning. The classification technique is not limited to the Naïve Bayes classifier, and other known techniques may be applied.

The query model is, for example, a classification learner which is trained to extract a sentence intended for question from a group of sentences. The search model is a classification learner which is trained to extract an FAQ (answer) appropriate for the sentence (question) extracted in the query model. Since the techniques for grouping and sorting sentences using the classification learner (model) are known technologies, detailed description thereof is omitted.

While the following description is made of FAQ creation assist based on the user support log accumulated in the single contact center, the present invention is applicable in an aspect in which contact centers are deployed in a plurality of sites . For example, the assist apparatus 100 can be connected to each of the contact centers (customer support management apparatuses 330) in those sites over a network and acquire user support logs in the contact centers to create FAQs. In this case, the assist apparatus 100 can create an integrated FAQ over the plurality of sites or create a different FAQ for each site.

In this manner, the customer support management apparatus 330 accumulates user support logs on a daily basis and provides user support using FAQs. A manager can extract and upload a plurality of user support logs from the customer support management apparatus 330 to the assist apparatus 100 according to Embodiment 1 to create an FAQ through the use of the knowledge information creation assist function. The created FAQ can be output in a predetermined data format (for example, a CSV format). The output FAQ information can be input to the customer support management apparatus 330 and used for user support based on FAQs (including putting the FAQ information on a website).

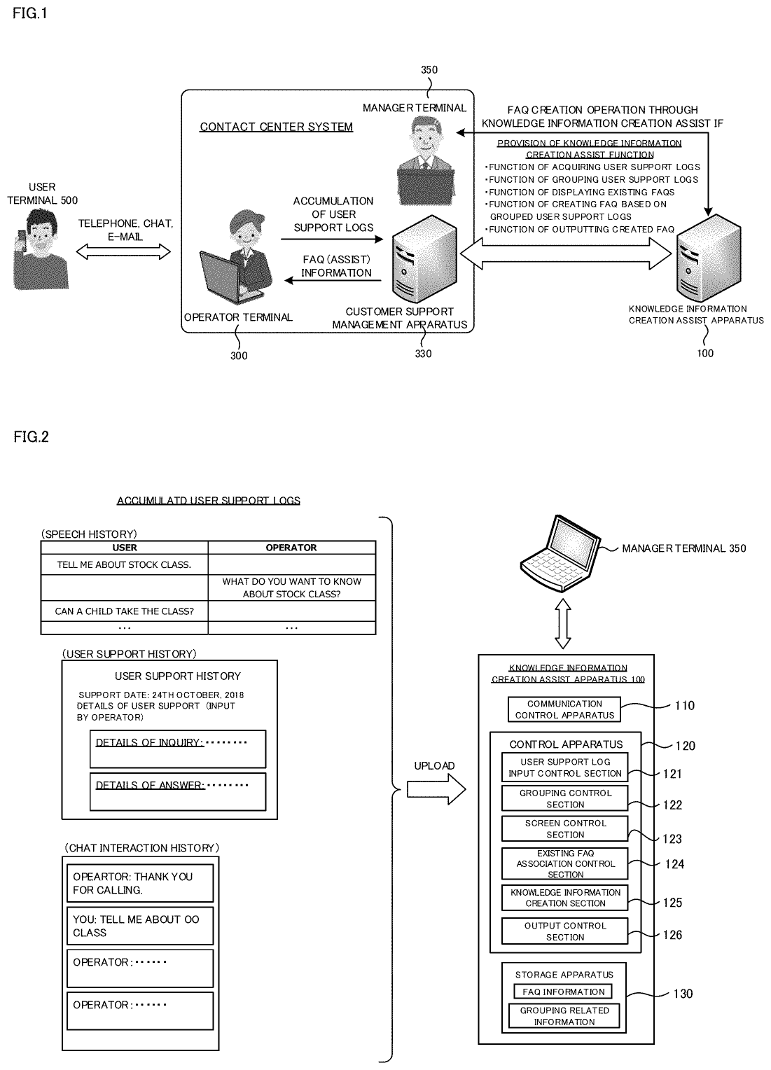

FIG. 2 is a diagram showing functional blocks of the assist apparatus 100 and an example of the accumulated user support logs. The assist apparatus 100 includes a communication control apparatus 110, a control apparatus 120, and a storage apparatus 130. The communication control apparatus 110 performs processing of connection and data communication with the manager terminal 350 or the customer support management apparatus 330 via networks such as the Internet or a predetermined dedicated network. The storage apparatus 130 stores the uploaded user support logs or the created FAQ information (existing FAQs), or stores various types of information including the classification learner (model) for use in the grouping function as grouping related information.

The control apparatus 120 includes a user support log input control section 121, a grouping control section 122, a screen control section 123, an existing FAQ association control section 124, a knowledge information creation section 125, and an output control section 126.

The user support logs are formed of combinations of questions and answers and are included in a speech history from interactions between users and operators, a user support history in the operator input scheme, a chat interaction history and the like. It should be noted that questions and answers are not unambiguously determined such that the question is what a user says and the answer is what an operator says. Thus, the “question” may include a user's question repeated or said in other words by an operator.

The speech history includes text data created through voice recognition processing from voice interactions between users and operators, and can be accumulated separately in user's speech and operator's speech as shown in FIG. 2. The user support history includes user support logs in the operator input scheme input by operators on the predetermined input screen described above. The chat interaction history includes a series of interactions in text form as described above.

These user support logs are created by the customer support management apparatus 330. The voice recognition processing can be performed by a voice recognition processing section incorporated in the customer support management apparatus 330 or an external voice recognition processing server.

A user support log file uploaded to the assist apparatus 100 may be handled as separate data (file) for each user support interaction or for each operator or maybe file data including a plurality of user support logs provided by collecting all the user supports. A plurality of questions may be included in the speech history, the user support history, and the chat interaction history. For example, in an interaction between a user and an operator, the user may ask questions in succession over time, and the operator may successively answer the questions. As a result, each of the histories may include a plurality of user support logs (a plurality of questions and answers).

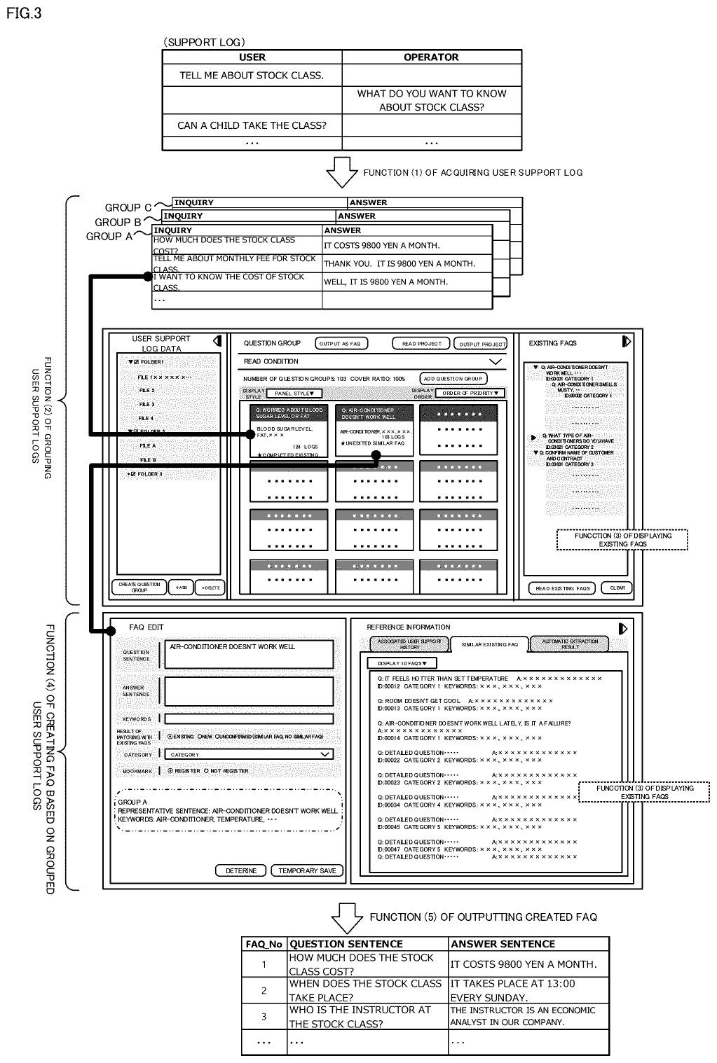

FIG. 3 is a diagram for explaining the assist function provided by the assist apparatus 100. First, the function (1) of acquiring (uploading) user support logs includes processing of receiving, from the manager terminal 350 (or the external storage apparatus connected to the manager terminal 350), a user support log file of the CSV format including question and answer sentences in the form of text data and storing the received file in the assist apparatus 100. The function (1) is performed by the user support log input control section 121. A plurality of user support log files may be acquired together.

Next, the function (2) of grouping and displaying the user support logs includes grouping “questions” in the uploaded user support logs by using a predetermined classification learner. The grouping is performed in the manner described above. For example, words in the question sentences can be quantified (weighted) based on the number of appearances of each word or the similarity between words to group similar question sentences or sentences having similar intention. The function (2) is performed by the grouping control section 122.

The grouping control section 122 can automatically extract a representative sentence representative of each group (representative question sentence) and keyword(s). The extracted representative sentence can be used as a group name.

The representative sentence and keyword can be produced, for example, by scoring the number of appearances of each word or the similarity between words in the question sentences. A word having a high number of appearances in the grouped question sentences can be extracted as a keyword, or a query model can be used to evaluate the grouped question sentences to select (extract) a question sentence having a high evaluation level as a representative sentence.

The result of the grouping is displayed on a screen as group information. Existing FAQs can be displayed together with the result of the grouping. The function (3) of reading and displaying existing FAQs includes displaying already created FAQs (already created knowledge information) created previously (in the past) with the knowledge information creation assist function and/or without the knowledge information creation assist function. The function (3) is performed by the existing FAQ association control section 124 which reads the existing FAQs previously stored in the storage apparatus 130 and displays the read FAQs on the screen together with the result of the grouping. As described later, the existing FAQ association control section 124 can also perform processing of association display in response to operation on the screen such as emphasizing an existing FAQ similar to any of the questions in the groups.

The function (4) of creating an FAQ based on the result of the grouping includes selecting group information (for example, group display panel) from the result of the grouping and creating an FAQ. When group information is selected, an FAQ creation screen (knowledge information creation screen) is displayed. On the FAQ creation screen, an FAQ can be created based on input operation performed by the manager (operator).

On the FAQ creation screen, an FAQ edit screen block and a reference information display block are displayed side by side. With reference to each information in the reference information display block, the manager performs input and edit in the FAQ edit screen block. The manager can select a “determine” button to create (produce) one FAQ for one group. The created FAQ is assigned predetermined FAQ identification information (FAQ_No) and stored in the storage apparatus 130. The FAQ edit and creation processing is performed by the knowledge information creation section 125.

The function (5) of outputting the created FAQ includes outputting, in the CSV format, the FAQ assigned unique FAQ identification information stored in the storage apparatus 130. In response to selection of a predetermined “output as FAQ” button, the output control section 126 converts the FAQ into an output file of the CSV format and transmits the file to the manager terminal 350.

The output control section 126 can perform control to output only the newly created FAQ, that is, the difference from the existing FAQs, or to output all the FAQs including the newly created FAQ as an existing FAQ. The output range of FAQs can also be arbitrarily set. The output format is not limited to the CSV format, and for example, any data format may be used as long as the customer support management apparatus 330 can acquire the data.

The screen control section 123 generally controls the display on the screens where the functions (1) to (5) are provided. The display control for the respective functions can be performed by the associated functional sections, and those functional sections cooperate with the screen control section 123 to control the overall display processing.

<Description of Processing of Knowledge Information Creation Assist Function and Screen Control>

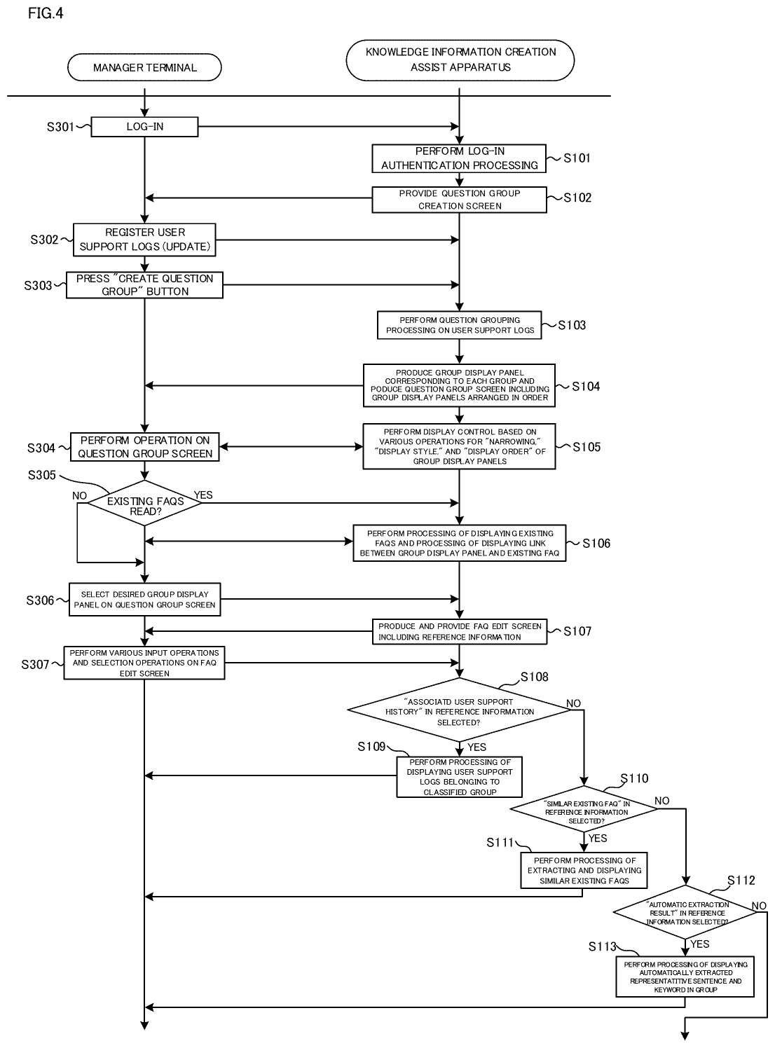

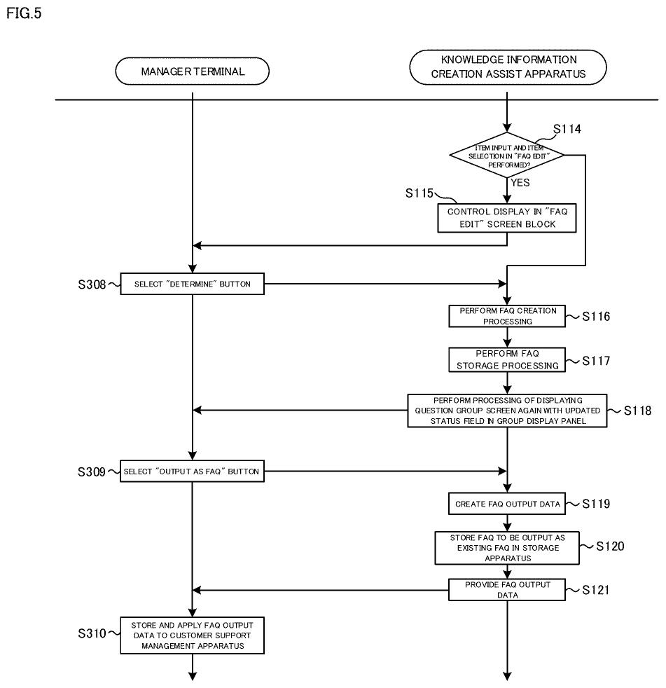

FIGS. 4 and 5 are diagrams showing a processing flow for achieving the knowledge information creation assist function provided by the assist apparatus 100. FIG. 5 is a flow chart subsequent to that in FIG. 4. FIGS. 6 to 13 are diagrams showing examples of the screens for use in the knowledge information creation assist function and display control.

First, the manager connects to the customer support management apparatus 330 from the manager terminal 350 and extracts user support logs including question and answer sentences in the form of text data. The customer support management apparatus 330 can have a function of outputting the user support logs in the CSV format, for example. The user support log file corresponds to data including a plurality of user support logs.

As shown in FIG. 4, the manager connects to the assist apparatus 100 from the manager terminal 350 and logs in to use the knowledge information creation assist function (S301). The assist apparatus 100 receives input of a previously issued (registered) user ID and password to perform log-in authentication (S101). If the log-in authentication succeeds, the assist apparatus 100 transmits a question group creation screen to the manager terminal 350 which in turn displays the screen (S102).

FIG. 6 is a diagram showing an example of the question group creation screen. The question group creation screen includes a user support log data display block, a question group display block, and an existing FAQ display block. The manager selects an “add” button to specify user support log files to be uploaded in the user support log data display block. The specified user support log files are transmitted from the manager terminal 350 to the assist apparatus 100 and stored in the storage apparatus 130, and the file names of those user support log files are displayed in list form in the user support log data display block (S302). To remove any file from the displayed user support log files for use in creating question groups, a “delete” button can be pressed to remove (delete) the file.

The user support log data display block includes a “create question group” button. The manager can select the “create question group” button (S303) to create a question group from the user support log files (the plurality of user support logs) displayed in list form within the user support log data display block. The grouping control section 122 performs question grouping processing on the uploaded single or plurality of user support log files by grouping the questions included in the user support logs through the use of the classification learner described above (S103). The screen control section 123 displays the grouped question groups in the question group creation display block.

The grouping control section 122 counts the user support logs included in each question group and performs processing of extracting a representative sentence and keyword(s). The question group name (or group ID), the number of belonging user support logs, and the representative sentence and keyword(s) are stored in the storage apparatus 130 as grouping related information for each question group. The grouping control section 122 creates information indicating the correspondence between each question group and the belonging user support logs and stores the information in the storage apparatus 130. For example, each question group can be associated with the IDs of the user support logs, or each group name (group ID) can be associated with the user support logs.

After the grouping processing, the screen control section 123 creates question group display information including at least the representative sentence, the number of belonging user support logs, and the keyword(s), and displays the created information in the question group creation display block (S104). An example of the question group display information is group display panels in the form of rectangular icons as shown in FIG. 6. Alternatively, the question groups may be displayed in rows of a table.

The question group creation display block is now described. In the question group creation display block, the manager can select one of display styles including list and panel styles and display the question groups in the selected style (S304). The example of FIG. 6 shows an aspect in which the panel style is selected, and a plurality of group display panels are arranged in order. The order of display of the plurality of question groups may also be specified (S304). The order of display may be based on the priority given to each question group (bookmark), the number of user support logs included in each question group or the like. The screen control section 123 controls the manner of display of the question groups according to the selected display style or the display order (S105).

The number of question groups and a cover ratio are displayed in the question group creation display block. The cover ratio refers to the ratio of the total number of the user support logs belonging to the groups displayed in the question group creation display block to the total number of the user support logs uploaded to the user support log data display block. In the example of FIG. 6, the cover ratio is displayed as 100% since the total number of the user support logs in all the displayed question groups is consistent with the total number of the user support logs uploaded to the user support log data display block.

With the cover ratio calculated and displayed in this manner, it is possible to know the proportion of the user support logs that can be covered by the question groups after narrowing, or in other words, to know how many question groups are needed to coverall the user support logs. Specifically, as the number of question groups is increased, the number of created FAQs is increased, and an increased number of FAQs allows detailed support suitable for the needs of users. However, an extremely increased number of FAQs provides too many options in user support and is likely to offer FAQs which do not exactly fit the needs of users. Such an increased number of FAQs also puts a great burden on the operator searching FAQs. Thus, instead of simply creating an FAQ from each of all the question groups covering 100% of the user support logs, creating FAQs from a set of question groups which are low in number but high in cover ratio can achieve FAQs which are efficient and likely to fit the needs of users. In addition to the viewpoint of the number of user support logs, the cover ratio can be calculated by taking account of information about time taken for user support and operator information obtained from the customer support management apparatus 330, thereby creating FAQs with a higher priority given to a question taking a longer time for user support or creating FAQs with a higher priority given to a user support log involving a highly regarded (experienced) operator.

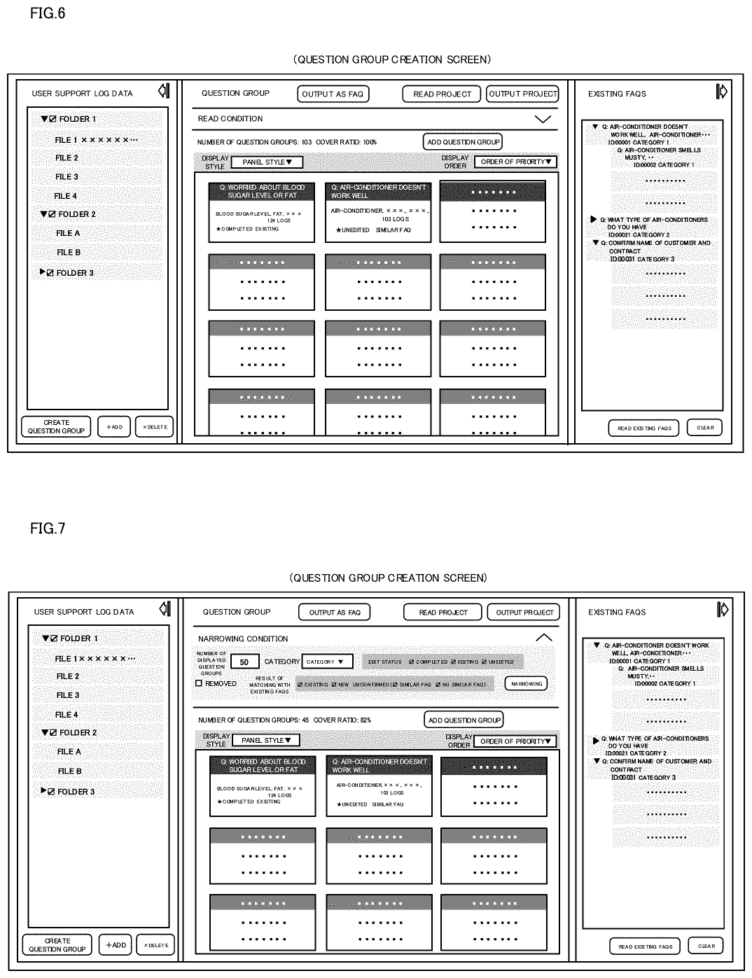

FIG. 7 is a diagram showing an example of the display result from narrowing condition processing in the question group creation screen. The question group creation display block shows a narrowing condition specification field including specification conditions such as the number of displayed question groups, category, edit status, removed, and result of matching with existing FAQs. The manger can specify any condition in the narrowing condition specification field (S304). The screen control section 123 searches all the question groups for any question group satisfying the specified narrowing conditions and displays the satisfying question groups in the question group creation display block (S105).

In the example of FIG. 7, 45 of 103 question groups are displayed as a result of the narrowing processing. The cover ratio is 82%. This means that 45 question groups constitute 82% of all the user support logs uploaded to the user support log data display block. It can be seen that the remaining 58 question groups not satisfying the narrowing conditions constitute 18% of all the user support logs.

The existing FAQ display block includes a “read existing FAQ” button. When the manager selects the “read existing FAQ” button, the existing FAQs stored in the storage apparatus 130 can be displayed (S305). FIG. 8 is a diagram showing a manner of display of the read existing FAQs. In response to selection of the “read existing FAQ” button, the screen control section 123 performs control to display the existing FAQs in the existing FAQ display block and to pick up an FAQ pointed (selected) with a cursor in the existing FAQ display block and display the content of that FAQ in a separate window (S106).

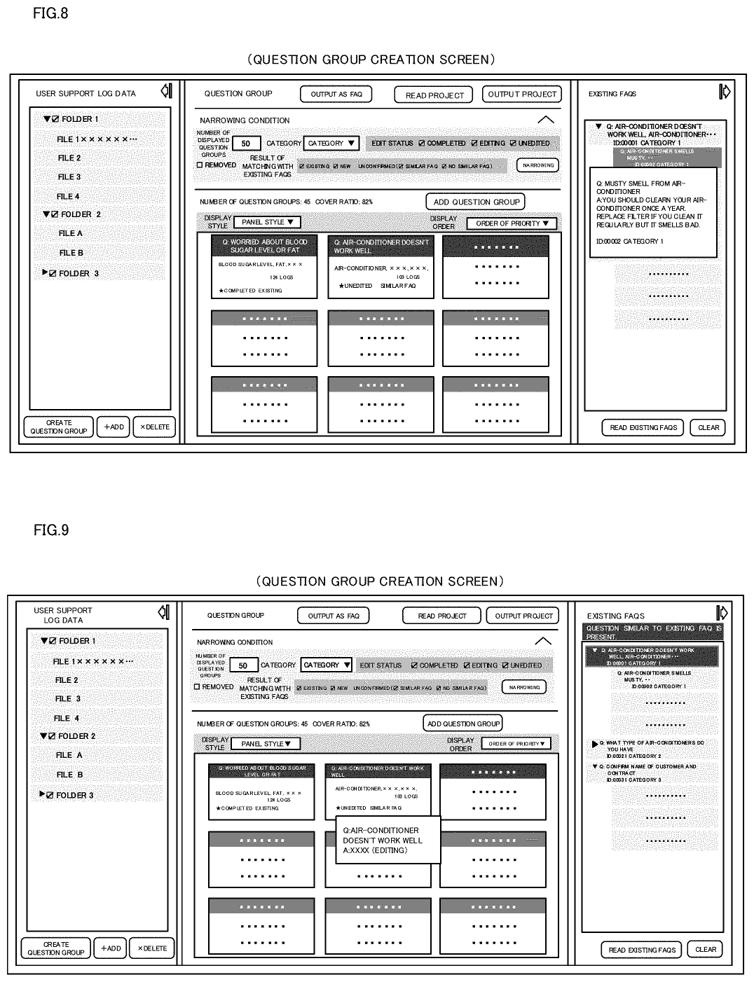

As shown in FIG. 9, when the displayed existing FAQs include an FAQ having a question similar to the question of a question group selected in the question group creation display block, the screen control section 123 performs control to emphasize the similar FAQ such that those questions are linked (associated). For example, when a predetermined question group is pointed with a cursor, the existing FAQ association control section 124 determines the similarity to the existing FAQs and extracts any existing FAQ having a predetermined similarity level or more or any existing FAQ having the highest similarity level through the use of the classification learner used by the grouping control section 122 in creating the question groups. Then, the screen control section 123 can emphasize (for example, highlight) the similar FAQ extracted by the existing FAQ association control section 124 in the existing FAQ display block and display a message such as “question similar to existing FAQ is present.”

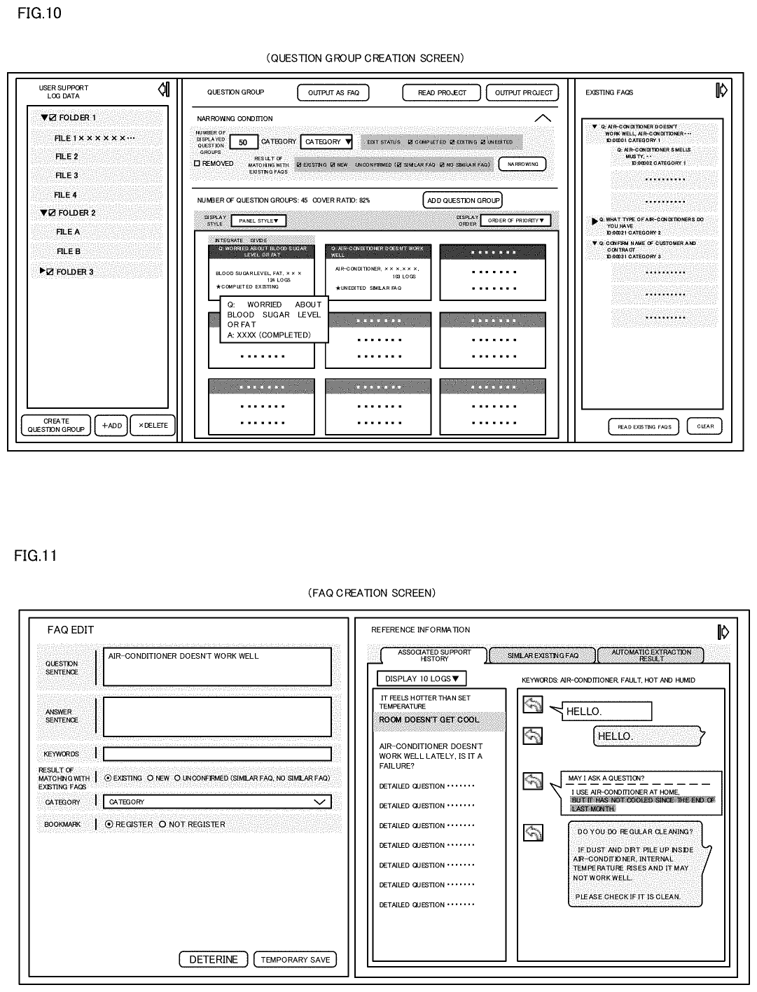

FIG. 10 is a diagram showing an example of display control for the group display panels (question groups). In the example of FIG. 10, the group display panels have “integrate” and “divide” buttons. When the “integrate” button is selected in a question group, the question group can be integrated with another question group. In response to selection of the “integrate” button, the grouping control section 122 integrates specified two or more question groups into one question group and stores the integrated group in the storage apparatus 130. The integrated new question group may employ a representative sentence and keyword(s) of any one of the two or more question groups as a representative sentence and keyword(s) of the new question group. Alternatively, the processing of extracting a representative sentence and keyword(s) may be performed again and the grouping related information in the storage apparatus 130 may be updated. The screen control section 123 performs display control for the integrated question group in the question group creation display block.

The “divide” button can be used to perform the question grouping processing again on the user support logs included in a specified question group to create and store two or more question groups in the storage apparatus 130. The divided question groups are again subjected to the processing of extracting a representative sentence and keyword(s).

Next, the manager can select a question group to create an FAQ. When a group display panel is selected (S306), the screen control section 123 displays an FAQ creation screen shown in FIG. 11 on the manager terminal 350 (S107). An FAQ edit screen block on the FAQ creation screen has a question sentence input field, an answer sentence input field, and a keyword input field. As shown in FIG. 11, the screen control section 123 may perform control to automatically display a representative sentence in the question sentence input field.

The screen control section 123 controls input to each input field and also controls selection of selection items including a result of matching with existing FAQs, category, and bookmark (priority). The selection items are associated with the narrowing conditions described above and manually set by the manager.

A reference information display block on the FAQ creation screen has a plurality of tabs. The manager can select one of the tabs to display reference information linked thereto (S307). The example of FIG. 11 shows “associated user support history” displayed as reference information. When the FAQ creation screen is displayed through screen transition from the question group creation screen, the screen control section 123 can perform control to automatically select a predetermined one of the plurality of tabs to display the linked reference information, or not to display any reference information until a tab is selected.

In the “associated response history,” the user support logs belonging to the question group are displayed. The screen control section 123 can extract and display the belonging user support logs based on the correspondence between the question groups and the user support logs stored in the storage apparatus 130 (YES at S108, S109). As shown in FIG. 11, in the reference information display block, the screen control section 123 can perform control to display only the question sentences included in the user support logs on the left and to display the original data included in a selected user support log on the right (for example, the speech history including the speeches of the respective speakers arranged in chronological order).

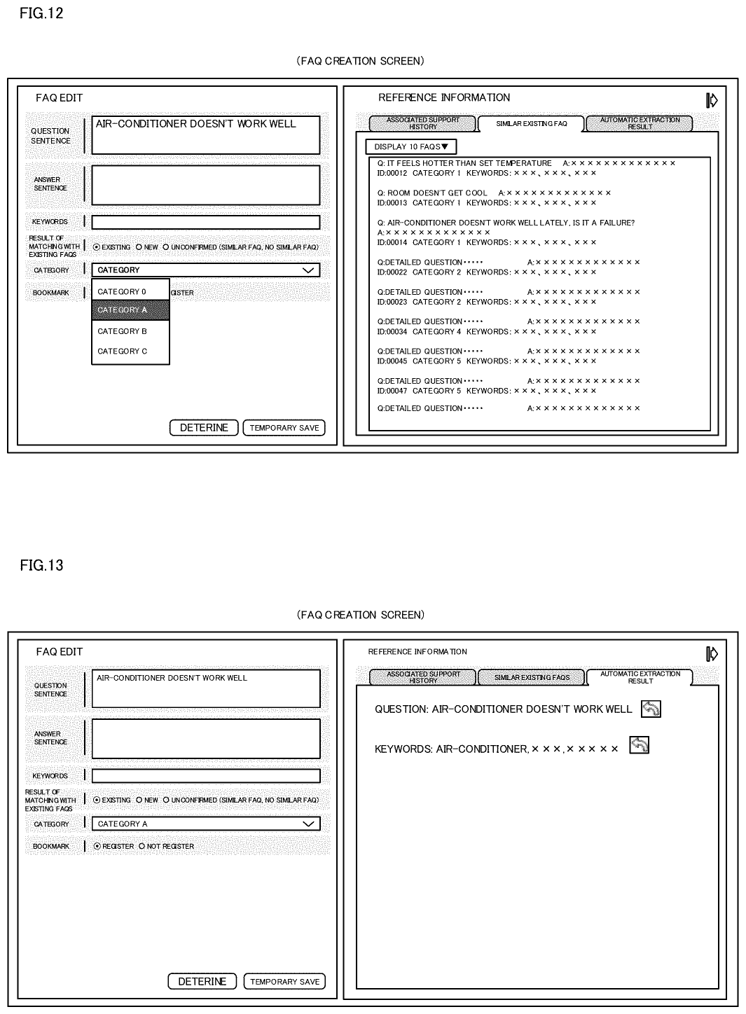

FIG. 12 is a diagram showing an example of display of “similar existing FAQ” in the reference information display block. In the “similar existing FAQ,” existing FAQs read on the question group creation screen are displayed (YES at S110, S111). FIG. 13 is a diagram showing an example of display of “automatic extraction result” in the reference information display block. In the “automatic extraction result,” the representative sentence and keyword(s) automatically extracted by the grouping control section 122 are displayed (YES at S112, S113).

With reference to various types of information in the reference information display block on the FAQ creation screen, the manager can input and edit a question sentence, input an answer sentence, and perform various selection operations for the selection items (S114, S115).

To create the combination of the input question sentence and answer sentence as an FAQ, the manager selects the “determine button” in the FAQ edit screen block (S308). In response to the selection of the “determine” button, the knowledge information creation section 125 assigns FAQ identification information (FAQ_No) to the set of the question sentence in the question sentence input field and the answer sentence in the answer sentence input field to create an FAQ (S116). The knowledge information creation section 125 stores the created FAQ in the storage apparatus 130 (S117).

After the creation of the FAQ on the FAQ creation screen, the screen control section 123 performs control to transition from the FAQ creation screen to the question group creation screen, thereby displaying the question group creation screen on the manager terminal 350. The screen control section 123 controls the display of the question group including the created FAQ such that the status of the question group is updated to “created” (S118). For example, in the example of FIG. 6, “completed” is displayed in the group display panel. For a question group with no FAQ created, “unedited” can be displayed.

After the creation of FAQ on the question group creation screen and the FAQ creation screen, the manager can output the FAQ for use in contact centers. In response to selection of the “output as FAQ” button” on the question group creation screen, the output control section 126 creates, for example, FAQ output data of the FAQ having the “created” status in the CSV format from the question groups displayed on the question group creation screen (S119). The output control section 126 can perform processing of setting the FAQ to be output as an existing FAQ and updating the status of the FAQs stored in the storage apparatus 130 (S120). With this configuration, the FAQ from the question group displayed on the present question group creation screen can be controlled not to be displayed as an existing FAQ and can be controlled to be displayed as an existing FAQ in the next creation processing.

The output control section 123 transmits the created FAQ output data to the manager terminal 350 (S121). The manager stores the FAQ downloaded from the assist apparatus 100 in the manager terminal 350 or the external storage apparatus. The manager then applies (acquires) the created FAQ to the customer support management apparatus 330 and utilizes the FAQ for support operations in the contact center.

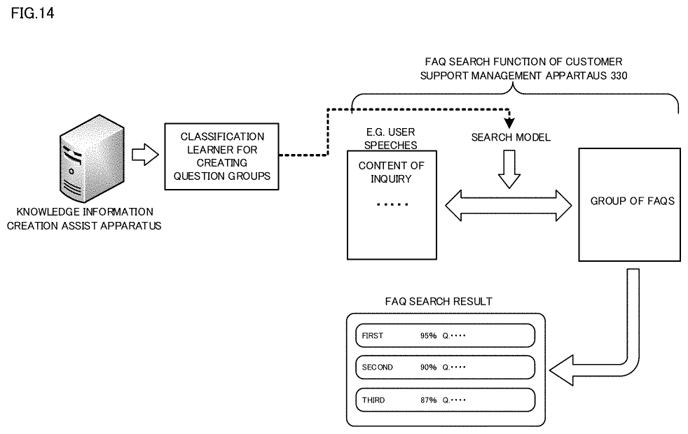

FIG. 14 is a conceptual diagram in which the question grouping model (classification learner) used in the knowledge information creation assist function according to Embodiment 1 is applied to an FAQ search function in a contact center. As shown in FIG. 14, a customer support management function in the contact center can include a function of searching for an appropriate FAQ based on the content of interactions in text form obtained through voice recognition. The FAQ search function uses the classification learner for searching for an FAQ having a question sentence similar to a question from a user. Thus, the question grouping model used in the knowledge information creation assist function according to Embodiment 1 can be applied to the customer support management apparatus 330. With this configuration, the question from the user can be associated with the original question group used in creating FAQs, and any FAQ having the similar question content can be searched for accurately.

The knowledge information creation assist system according to Embodiment 1 can manually create FAQs from a large amount of user support logs without cumbersome operation and can reduce the cost in creating and maintaining the FAQs.

While the embodiment has been described, the knowledge information creation assist apparatus 100 and the customer support management apparatus 330 may be implemented as an integrated computer system. In other words, the customer support management apparatus 330 may be configured to include the functions of the knowledge information creation assist described above.

The user terminal 500 includes a multi-functional cellular phone such as a smartphone, a mobile communication terminal apparatus such as a Personal Digital Assistant (PDA), and an information processing terminal apparatus such as a personal computer having a calling function, a communication function, and a computing function. Each of the operator terminal 300 and the manager terminal 350 is implemented by a computer apparatus equipped with a browser which performs processing of displaying the various screens described above.

The knowledge information creation assist apparatus 100 can include, as a hardware configuration, a memory (main storage apparatus), operation input means such as a mouse, keyboard, touch panel, and scanner, output means such as a printer, and an auxiliary storage apparatus (such as a hard disk), in addition to the components described above.

The functions of the present invention can be implemented by a program. A computer program previously provided for implementing each function can be stored on an auxiliary storage apparatus, the program stored on the auxiliary storage apparatus can be read by a control section such as a CPU to a main storage apparatus, and the program read to the main storage apparatus can be executed by the control section to allow a computer to perform the function of each component in the present invention. Each of the functions of the present invention can also be implemented by a different one of apparatuses, and those apparatuses can be connected directly or via a network to constitute a computer system.

The program may be recorded on a computer readable recording medium and provided for the computer. Examples of the computer readable recording medium include optical disks such as a CD-ROM, phase-change optical disks such as a DVD-ROM, magneto-optical disks such as a Magnet-Optical (MO) disk and Mini Disk (MD), magnetic disks such as a floppy disk® and removable hard disk, and memory cards such as a compact flash®, smart media, SD memory card, and memory stick. Hardware apparatuses such as an integrated circuit (such as an IC chip) designed and configured specifically for the purpose of the present invention are included in the recording medium.

While the embodiment of the present invention has been described, the embodiment is only illustrative and is not intended to limit the scope of the present invention. The novel embodiment can be implemented in various other forms, and various omissions, substitutions, and modifications can be made thereto without departing from the spirit or scope of the present invention. The embodiment and its variations are encompassed within the spirit or scope of the present invention and within the invention set forth in the claims and the equivalents thereof.

### DESCRIPTION OF THE REFERENCE NUMERALS

100 Knowledge Information Creation Assist Apparatus
110 Communication Control Apparatus
120 Control Apparatus
121 User Support Log Input Control Section
122 Grouping Control Section
123 Screen Control Section
124 Existing Faq Association Control Section
125 Knowledge Information Creation Section
126 Output Control Section
130 Storage Apparatus
300 Operator Terminal
330 Customer Support Management Apparatus
350 Manager Terminal
500 User Terminal

1. A knowledge information creation assist apparatus for providing a function of assisting creation of knowledge information relating to a question, comprising:
an input control section configured to control upload of a plurality of user support histories including questions;
a screen control section configured to perform first display control for displaying, on a display apparatus, a question group creation screen including group information of each of question groups created from the user support histories classified according to a predetermined classification model and second display control for displaying, on the display apparatus, a knowledge information creation screen for producing knowledge information in response to input performed by a creator to one of the question groups selected on the question group creation screen; and
an output control section configured to produce output data of the knowledge information created for each of the question groups on the knowledge information creation screen.

2. The knowledge information creation assist apparatus according to claim 1, further comprising a grouping control section configured to classify the uploaded user support histories according to the predetermined classification model to group more than one of the user support histories into a plurality of question groups,
wherein the grouping control section is configured to create a representative question sentence and a keyword of each question group from at least one of the user support histories classified as belonging to the question group, and
the screen control section is configured to display the group information in the first display control such that the group information includes the representative sentence and the keyword.

3. The knowledge information creation assist apparatus according to claim 1, wherein the question groups are created by grouping of all the uploaded user support histories, and
the screen control section is configured to perform display control for displaying only at least one of the question groups satisfying a specified narrowing condition on the question group creation screen, to calculate a ratio of a second score calculated from at least one of the user support histories belonging to the at least one of the question groups satisfying the narrowing condition to a first score calculated from all the uploaded user support histories, and to display the calculated ratio on the question group creation screen.

4. The knowledge information creation assist apparatus according to claim 3, wherein the scores are calculated from the number of the user support histories, and
the screen control section is configured to calculate a ratio of a total number of the at least one of the user support histories belonging to the at least one of the question groups satisfying the narrowing condition to a total number of all the uploaded user support histories, and to display the calculated ratio on the question group creation screen.

5. The knowledge information creation assist apparatus according to claim 3, wherein the scores are calculated from a time taken for user support, and
the screen control section is configured to calculate a ratio of a total support time in the at least one of the user support histories belonging to the at least one of the question groups satisfying the narrowing condition to a total support time in all the uploaded user support histories, and to display the calculated ratio on the question group creation screen.

6. The knowledge information creation assist apparatus according to claim 1, wherein the screen control section is configured to perform display control for reading created knowledge information stored in a predetermined storage apparatus and displaying the read knowledge information on the question group creation screen,
the knowledge information creation assist apparatus further comprising an association control section configured to extract at least one piece of the created knowledge information similar to one of the question groups based on similarity between the created knowledge information and the question groups,
wherein the screen control section is configured to perform display control for indicating the presence of at least one extracted piece of the displayed created knowledge information similar to a selected one of the question groups on the question group creation screen in the first display control, and display control for displaying a list of pieces of the created knowledge information based on a score of relevance to the selected question group in the second display control.

7. The knowledge information creation assist apparatus according to claim 1, wherein the screen control section is configured to perform integration display control based on operation for integrating more than one of the grouped question groups and division display control for dividing one of the question groups into a plurality of question groups.

8. The knowledge information creation assist apparatus according to claim 1, wherein the knowledge information creation screen includes an edit screen block for receiving input performed by a creator and a reference information display block, and
the screen control section is configured to perform display control processing of displaying the user support histories belonging to the question groups, the created knowledge information stored in a predetermined storage apparatus, and/or the representative sentence and the keyword of each question group created based on at least one of the user support histories classified as belonging to the question group in the reference information display block in response to operation performed by a creator.

9. A program for providing a function of assisting creation of knowledge information relating to a question, the program comprising instructions which, when executed by a computer, cause the computer to perform:
a function of controlling upload of a plurality of user support histories including questions;
a function of performing first display control for displaying, on a display apparatus, a question group creation screen including group information of each of question groups created from the user support histories classified according to a predetermined classification model and second display control for displaying, on the display apparatus, a knowledge information creation screen for producing knowledge information in response to input performed by a creator to one of the question groups selected on the question group creation screen; and
a function of producing output data of the knowledge information created for each of the question groups on the knowledge information creation screen.

10. A knowledge information creation assist system for providing a function of assisting creation of knowledge information relating to a question, comprising:
an input control section configured to receive a plurality of user support histories including questions in response to upload operation on a terminal of a creator creating knowledge information;
a screen control section configured to perform first display control for displaying, on the terminal, a question group creation screen including group information of each of question groups created from the user support histories classified according to a predetermined classification model and second display control for displaying, on the terminal, a knowledge information creation screen for producing knowledge information in response to input performed by the creator to one of the question groups selected on the question group creation screen; and
an output control section configured to produce and output output data of the knowledge information created for each of the question groups on the knowledge information creation screen in response to download operation on the terminal.
